(19) United States
(12) Patent Application Publication
(10) Pub. No.: US 2003/0211835 A1
(43) Pub. Date: Nov. 13, 2003

(54) Mobile phone with changeable keypad

(75) Inventors: Long-Jyh Pan, Shijr City (TW); Hsiao-Wu Chen, Pingjen City (TW)

Correspondence Address: Richard P. Berg, Esq., c/o LADAS & PARRY, Suite 2100, 5670 Wilshire Boulevard, Los Angeles, CA, 90036-5679, US

(73) Assignee: BENQ CORPORATION

(21) Appl. No.: 10/435,148

(22) Filed: May 9, 2003

(30) Foreign Application Priority Data
May 10, 2002 (TW) 91206666

(51) Int. Cl. H04M 1/00; H04M 9/00

(52) U.S. Cl. 455/90.3; 455/575.1; 455/550.1; 379/433.05; 379/433.07; 379/433.11

(57) ABSTRACT

A mobile phone with a changeable keypad. The mobile phone has a connecter disposed on a main board mounted on a frame assembly and a keypad having a second PCB with a plurality of keys. The keypad is movably disposed on the frame assembly through a groove. The second PCB of the keypad is detachably connected to the main board through the connecter, such as a spring-type connecter or an FPC.

### BACKGROUND OF THE INVENTION

1. Field of the Invention

The present invention relates to a mobile phone, and in particular to a mobile phone having a changeable keypad.

2. Description of the Related Art

As technology improves, mobile phones must provide better communication quality, lower radiation, lower power consumption, smaller profile and more characteristic appearance. FIG. 1 is schematic view of a conventional mobile phone. The conventional mobile phone 10 has a main board (not shown) with a liquid crystal display module (LCD module), a key assembly 12 and a housing 11 to protect the electronic elements disposed inside. Previously, the key assembly 12 has had a print circuit board, or PCB, (not shown) with a plurality of keys disposed thereon. It is commonly integrated into, or welded onto, the main board of the mobile phone 10. Thus, the key assembly 12 cannot be replaced.

Moreover, many housings of conventional mobile phones are changeable to satisfy user desires. There is still a need, however, to have a mobile phone with a changeable key assembly to provide more personalized variations.

### SUMMARY OF THE INVENTION

Accordingly, an object of the invention is to modify the connection between the PCB of the key assembly and the main board of a mobile phone. The key assembly is modified into a keypad, removeably connected to the main board and easily replaced to diversify the appearance of the mobile phone and satisfy consumers.

The present invention provides a mobile phone with a changeable keypad. The mobile phone comprises a first PCB with a connecter and a keypad. The keypad has a second PCB and a plurality of keys. The second PCB is detachably and electrically connected to the first PCB through the connecter, such that the keypad can be exchanged.

According to the invention, the connecter is a spring-type connecter or a flexible print circuit (FPC) connecter. The connecter of the first PCB electrically connects the electrodes on the second PCB of the keypad.

Moreover, the mobile phone further comprises a frame assembly for securing the first PCB. The frame assembly has a groove. The keypad is detachably disposed on the frame assembly and slides along the groove.

Moreover, a housing is movably disposed on the frame assembly. The frame assembly has a tip portion with a flexible hook to secure the keypad to a predetermined position within the groove. When the keypad is not located in the predetermined position, it lifts the flexible hook, such that the housing cannot be fixed on the frame assembly.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is schematic view of a conventional mobile phone as referenced in the Prior Art;

FIG. 2 is an exploded view of the mobile phone of the invention;

FIG. 3A is a schematic view of the mobile phone with the housing removed of the first embodiment;

FIG. 3B is a back view of the keypad in FIG. 3A;

FIG. 4A is another schematic view of the mobile phone with the housing removed of the second embodiment;

FIG. 4B is a partially enlarged view of the connecter in FIG. 4A; and

FIG. 5 is a partial cross section of the housing of the present invention.

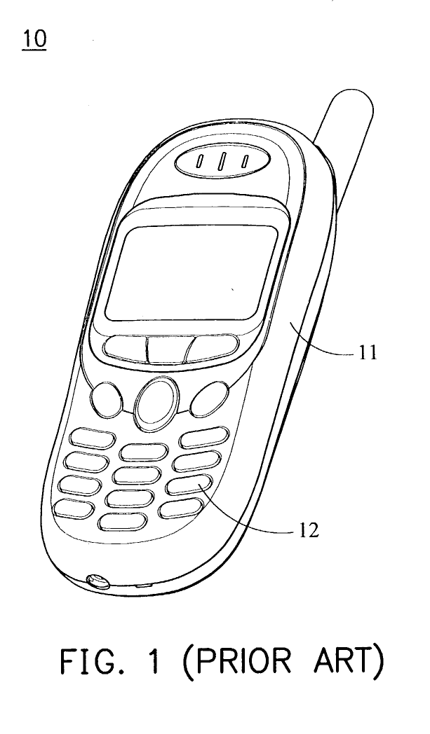

### DETAILED DESCRIPTION OF THE INVENTION

First Embodiment

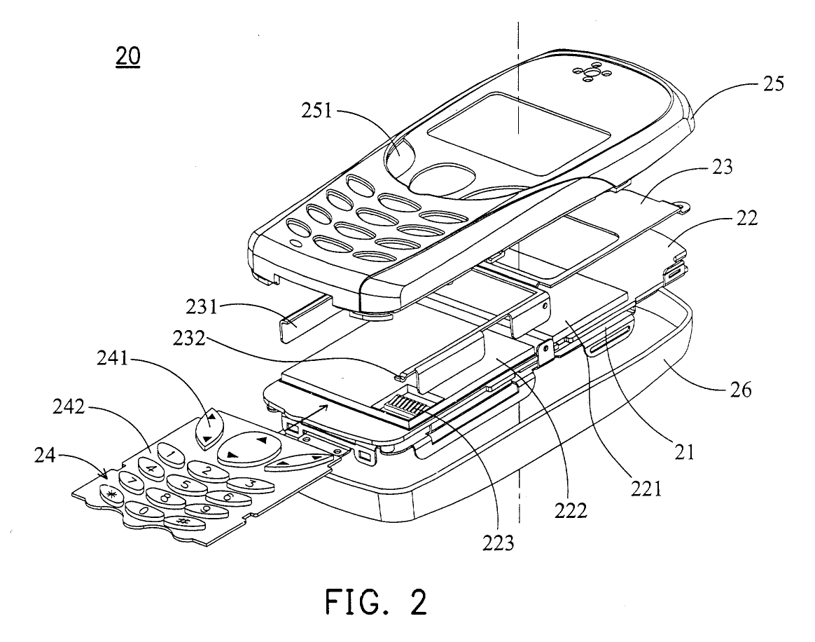

FIG. 2 is an exploded view of the mobile phone of the invention. In FIG. 2, the mobile phone 20 has a frame assembly consisting of a bottom frame 21 and a top frame 23, a housing 25, 26, a first PCB 22 and a changeable keypad 24. In order to simplify the drawing, battery, RF module, and other electronic elements disposed on the first PCB 22 are not shown.

The frame assembly includes a top frame 23 and a bottom frame 21, of metal or plastic. The bottom frame 21 secures the main board 22, the battery (not shown), the top frame 23 and the housing 25, 26.

The first PCB 22, or the main board, is engaged with, or bolted to, the bottom frame 21. The first PCB 22 has a LCD module 221, a spring-type connecter 223 and other electronic elements (not shown), such as a microprocessor, disposed thereon. Furthermore, the first PCB 22 has a metal jacket 222 covering the circuit and electronic elements of the first PCB 22 to reduce radiation.

The top frame 23 is engaged with, or bolted to the bottom frame 21 to strengthen the structure and protect the first PCB 22 from damage. The top frame 23 has a groove 231 to install the keypad 24. The keypad 24 can be inserted along the groove 231 and movably disposed on the frame assembly. The top frame 23 also has a tip portion with a flexible hook 232 near the end of the groove 231. The flexible hook 232 is to secure the keypad 24 to a predetermined position within the groove 231.

The keypad 24 has a second PCB 242, or a key PCB, and a plurality of function keys 242 arranged thereon. When the keypad 24 is inserted into the groove 231 and located in the predetermined position, the second PCB 242 of the keypad 24 is electrically connected to the first PCB 22. Thus, the microprocessor disposed on the first PCB 22 executes functions according to the command signals input from the keypad 24 to display data on LCD module 221 or control the RF module to send or receive radio waves.

In FIG. 2, the housing includes a first part 25 and a second part 26, detachably mounted to the bottom frame 21 to allow changing of the housing. The first part 26 of the housing has a plurality of holes 251 with respect to the function keys 241 of the keypad 24. As well, the housing 25, 26 protects the electronic elements inside.

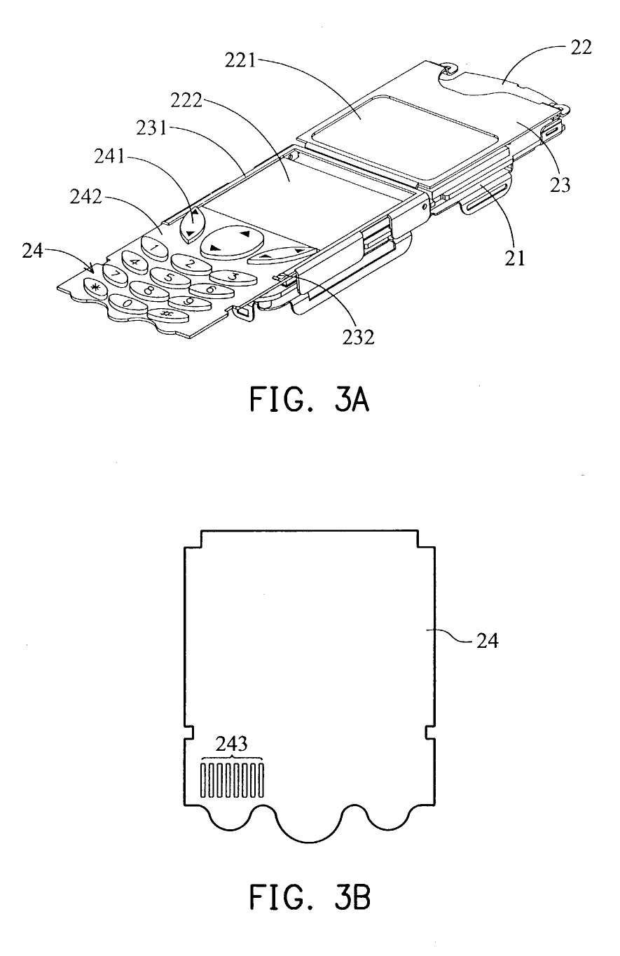

FIG. 3A is a schematic view of the mobile phone with the housing removed of the first embodiment, and FIG. 3B is a back view of the keypad in FIG. 3A. In FIGS. 3A and 3B, when the keypad 24 is inserted into the groove 231 of the top frame 23 and locked by the flexible hook 232 in the predetermined position, the spring-type connecter 223 of the first PCB 22 contacts the gold finger 243, or metal electrodes, located on the back surface of the second PCB 224. Signals from the keypad 24 are transmitted to the first PCB 22 though the spring-type connecter 223. Thus, according to the structure mentioned above, users can easily change keypads 24 and housings 25, 26 without needing tools.

Second Embodiment

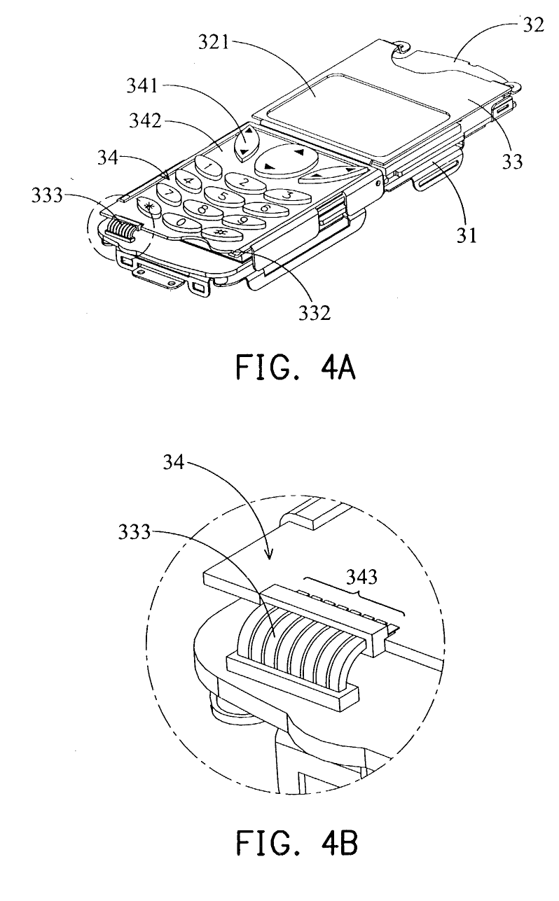

The present invention provides another embodiment for the connecter between the keypad and the first PCB. FIG. 4A is another schematic view of the mobile phone with the housing removed of the second embodiment, and FIG. 4B is a partially enlarged view of the connecter in FIG. 4A. In FIGS. 4A and 4B, at the edge of the second PCB 342 of the keypad 34 has a gold finger 343, or metal electrodes. The first PCB 32, or the main board, has a connecter 333. The connecter 333 is a flexible print circuit (FPC) connecter, welded on the first PCB 32 at one end and detachably and electrically connected to the gold finger 333 on the second PCB 342 at the other end. As well, the signal from the keypad 34 is transmitted to the first PCB 32 though the FPC connecter 333. Users can easily change keypads 34 and housings (not shown) and modify the appearance of the mobile phone of the present invention.

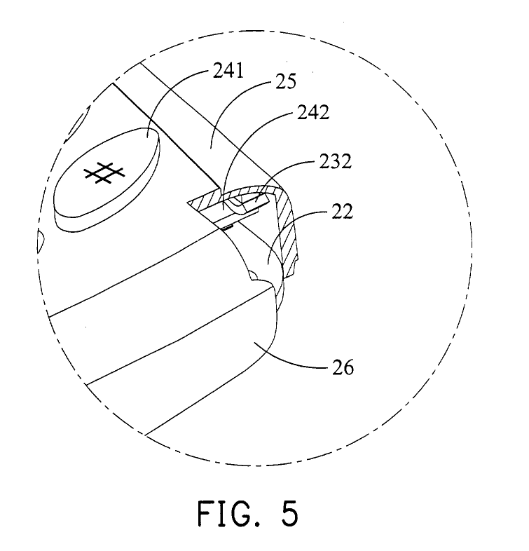

FIG. 5 is a partial cross section of the housing of the present invention. In FIGS. 2 and 5, the keypad 24 may sometimes not achieve the predetermined position, creating a contact fault between the gold finger and the connecter 223. Therefore, the flexible hook 223 has another protection function. If the keypad 24 is not inserted to the predetermined position, the keypad 24 pushes and lifts the flexible hook 232, and the first part 25 of the housing cannot engage with the frame assembly 21, 23. Thus, the flexible hook 232 can prevent contact fault between the gold finger and the connecter 223.

Furthermore, as shown in FIG. 2, the frame assembly, including the top frame 23 and the bottom frame 21 bolted or engaged together, protects the first PCB 22 from damage when changing the keypad 24. The keypad 24 is inserted along the groove 231 of the top frame 23 and electrically connected to the first PCB 22 through the connecter 223. Otherwise, the groove 231 in the above embodiments is not limited to location at the top frame 23. The groove can be alternatively disposed on the bottom frame 21 with another fixing member to secure the keypad 24 and reduce the number of elements.

The mobile phone of the invention uses the spring-type connecter 223 (in FIG. 2) or the FPC connecter 333 (in FIG. 4A) to electrically connect the main board and the changeable keypad. Thus, users can easily change the keypad in several steps and vary the appearance of mobile phones.

Moreover, the keypad of the invention is changeable. When the keypad is out of order, the mobile phone can be fixed by adding a new keypad, instead of replacing the entire main board. Thus, it saves time and reduces expense.

Besides, depending on the different keypad function request, users can change different keypads for game or for phone calling.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A mobile phone with a changeable keypad, comprising:
a first print circuit board;
a connecter, disposed on the first print circuit board; and
a keypad, having a second print circuit board and a plurality of keys disposed thereon, wherein the second print circuit board is detachably and electrically connected to the first print circuit board through the connecter.

2. The mobile phone as claimed in claim 1, wherein the connecter is a spring-type connecter.

3. The mobile phone as claimed in claim 1, wherein the connecter is a flexible print circuit connecter.

4. The mobile phone as claimed in claim 1, further comprising a frame assembly, mounting the first print circuit board.

5. The mobile phone as claimed in claim 4, wherein the frame assembly has a groove, and the keypad is movably disposed on the frame assembly and slides along the groove.

6. The mobile phone as claimed in claim 5, further comprising:
a housing, detachably mounted on the frame assembly and having a plurality of holes with respect to the keys of the keypad.

7. The mobile phone as claimed in claim 5, wherein the frame assembly has a tip portion with a flexible hook to secure the keypad to a predetermined position within the groove.

8. The mobile phone as claimed in claim 7, wherein when the keypad is not located in the predetermined position, the keypad lifts the flexible hook, such that the housing cannot be fixed on the frame assembly. 1. A thing, comprising:
